(19) United States
(12) Patent Application Publication
(10) Pub. No.: US 2003/0060220 A1
(43) Pub. Date: Mar. 27, 2003

(54) Polled tone synchronization of receiver/transmitter units

(76) Inventor: Nathan J. Hays, San Francisco, CA (US)

Correspondence Address: James C. Wray, Suite 300, 1493 Chain Bridge Road, McLean, VA, 22101, US

(21) Appl. No.: 09/956,877

(22) Filed: Sep. 21, 2001

(51) Int. Cl. H04B 7/005

(52) U.S. Cl. 455/502; 455/503

(57) ABSTRACT

Spread Aloha Multiple Access (SAMA) or other multiple access hubs provide feedback to each RTU on the frequency error in its transmission, so that each RTU can change its frequency output to the correct transmission frequency. At any time, and especially when a RTU has not transmitted for a time or is not transmitting, or during transmission, the hub requests that an RTU broadcast a pure tone of frequency. That pure tone produces a beat with the hub's detector. The hub filters the beat frequency and passes it to a comparator that produces a signal waveform. The period of the waveform is measured by the hub. The hub calculates the error in the RTU's carrier and sends a correction value for the RTU to use when transmitting. The hub measures slow drift in the carrier during continued transmission from a RTU and provides corrections to the RTU on the fly.

### BACKGROUND OF THE INVENTION

There are two major types of frequency error in the Spread Aloha Multiple Access (SAMA) and other multiple access systems, the common mode which affects all Spread Aloha Multiple Access (SAMA) Receiver/Transmitter Units (RTU's), and those offsets unique to each RTU. Current systems call for each RTU to derive a global reference from the broadcast DVB channel. No provision is made for canceling the common mode frequency offsets.

Needs exist to improve signal frequency accuracies and to avoid frequency drifts in remote transmitters.

### SUMMARY OF THE INVENTION

This invention describes new and different methods of synchronizing the Receiver/Transmitter Units (RTU) transmit frequencies that inherently solve the common mode offset problem and only require the SAMA or other multiple access transmitter to be linked to the broadcast channel by the software protocol.

The new Polled Tone Synchronization (PTS) method is a means by which the SAMA or other multiple access hubs provide feedback to each RTU on the frequency error in its transmission, so that each RTU can change its frequency output to the correct transmission frequency. At any time, and especially when a RTU has not transmitted for a time or is not transmitting, or during transmission, the hub requests that an RTU broadcast a pure tone of frequency. That pure tone produces a beat with the hub's detector. The hub filters the beat frequency and passes it to a comparator that produces a signal waveform. The period of the waveform is measured by the hub. The hub calculates the error in the RTU's carrier and sends a correction value for the RTU to use when transmitting. The hub measures slow drift in the carrier during continued transmission from a RTU and provides corrections to the RTU on the fly.

If the RTU is not transmitting, the hub requests a ping or pure tone signal and sends a correction to the RTU. The corrections, which are very small, for example 4 parts per million, are important in meeting coherence requirements in multiple access channels, for example Spread Aloha Multiple Access SAMA channels.

Coherence is the amount of phase error in a specific length of time. The units work out to those of frequency (Hz). This frequency is the difference between the transmitter carrier and the receiver demodulator, including all stages of mixing. Once a coherence is specified, it can be related to the reference accuracy by an uplink frequency, for example a coherence frequency by the 14 GHz Ku band uplink frequency.

The amount of allowable phase error is set by the maximum crosstalk between in-phase and quadrature signals. That can be calculated as the ratio of the crossed signal to the desired signal. From simple trigonometry, the ratio is the tangent of the phase angle. The maximum crosstalk is −10 dB. The arctan (1/10)=5.7° or about 1/60 of a wave. To determine a particular coherence requirement, divide 1/60 by the desired coherence time. This gives the coherence as a frequency offset from nominal.

In specifying coherence time for the SAMA system, the various rates used in the channel are:

| | |
|---|---|
| Sample rate | This is the rate at which the I/Q analog to |
| | digital converters are run. The sample rate is 16 |
| | MSPS. The chips are over sampled by 8x. |
| Baud time | This is the modulation rate of the 70 MHz carrier |
| | or how often a transition in quadrature angle is |
| | made. Each transition represents two chips. The |
| | Baud rate is 2 MHz or ⅛ the sample rate. |
| Symbol time | The spreading code is 31 chips long. The PN match |
| | filter produces a symbol every 31 Bauds for a |
| | symbol time of 15.5 microseconds. Each symbol |
| | represents two bits. The data rate is 129 KBPS. |
| Sync time | Every packet starts with a 24 bit sync field. The |
| | packet sync filter looks for this field. It is |
| | 186 microseconds long. |
| Packet time | The longest packets are 840 bits of data plus 24 |
| | bits of sync for a total time of 6.7 milliseconds. |

There are four specifications of coherence depending on the implementation of the SAMA receiver:

a) The most stringent requirement is that the angle not drift across an entire packet. This requirement must be met if there is no means of tracking phase when extracting the data stream. A packet may be as long as 6.7 mS, so the coherence must be less than 2.7 Hz. This is 0.2 parts per billion (ppb).

b) If the hub includes a phase tracking mechanism, but still requires the packet sync detector to work on coherent data, then the coherence time is 186 microseconds for a frequency of 90 Hz. This is 6 ppb.

c) If phase tracking occurs before the packet sync detector, then the requirement is for coherence across a symbol time of 15.5 microseconds. This implies a coherence frequency of 1,075 KHz or 0.08 ppm.

d) If phase tracking can be achieved on a sub-symbol level, perhaps only requiring the signal not rotate more than 60 every chip, then the coherence time is 0.5 microseconds for a frequency of 33 KHz or 2.4 ppm.

In SAMA systems identical spreading codes are used. Because every data bit is spread into chips by the same sequence, there is a determined frequency spectrum for the SAMA channel. The spreading code is:

0101010010010011000110000001111

The longest run of 0's is 6 (including the tail of the previous spread). This implies a lower frequency limit of 12 chips or 167 KHz. The upper limit is two chips or 1.0 MHz. The in-phase/quadrature (I/Q) filters in the hub bandpass these frequencies prior to the analog to digital converters. This leaves a low frequency band that can be used for transmitting the Polled Tone Synchronization (PTS) signal. The actual bandwidth required by the PTS system is determined by the worst case frequency offset and a minimum beat frequency for measurement.

The common mode errors derive from inaccuracy in the satellite transponder, Doppler shift, large step sizes in the teleport down converters, and the stability of the 10 MHz reference used by the hub. Cumulative effects may be as high as 125 KHz in the common mode. A particular example, Satmex 5, is specified to not exceed 10 ppm or 140 KHz. It is not the long term offset that is of concern, because the hub can be initially tuned to remove the offset. It is the shorter term variances such as the month to month drift that the PTS method must allow. For Satmex 5, this is 1 ppm or 14 KHz. This is the largest common mode contributor.

The expected frequency variance of the RTU's is limited by the quality of the crystal source selected. A moderately priced temperature controlled crystal oscillator (TCXO) has a lifetime variance of 5 ppm or 70 KHz. By adding the common mode and RTU offsets, the beat frequency will span less than 100 KHz.

When the beat frequency is detected by the hub, its period is measured by a 70 MHz counter and a beat counter. When the first edge of the beat signal arrives, the 70 MHz counter is started. After enough beats have passed, the counter is stopped, and its value is made available to the digital signal processor (DSP). By dividing the counter value by the number of beats detected, the average period of the beat frequency is determined. The minimum number of beats needed can be determined from the required accuracy, the 70 MHz quantization and the measurement noise.

If it is assumed that 40 samples in 4 milliseconds is sufficient, then the minimum beat frequency should be 10 KHz. Adding half the expected range of offsets, the nominal beat frequency is 60 KHz or 4.3 ppm at the 14 GHz uplink frequency. The RTU will program its IF to be 70 MHz +4.3 ppm or 70,000,301 Hz. This will cause the phase-locked 14 GHz transmitter to have the required 60 KHz offset.

The highest expected frequency is 110 KHz, which is an octave lower that the lowest SAMA frequency content. If an RTU keeps a record of its last PTS correction and uses it, it will likely not produce a worst case offset that might interfere with the SAMA channel.

These and further and other objects and features of the invention are apparent in the disclosure, which includes the above and ongoing written specification, with the claims and the drawings.

### BRIEF DESCRIPTION OF THE DRAWINGS

FIG. 1 schematically shows the invention.

FIG. 1 schematically shows the hub activities.

FIG. 3 shows steps in on-the-fly frequency correction.

FIG. 4 shows periodic correction.

### DETAILED DESCRIPTION OF THE PREFERRED EMBODIMENTS

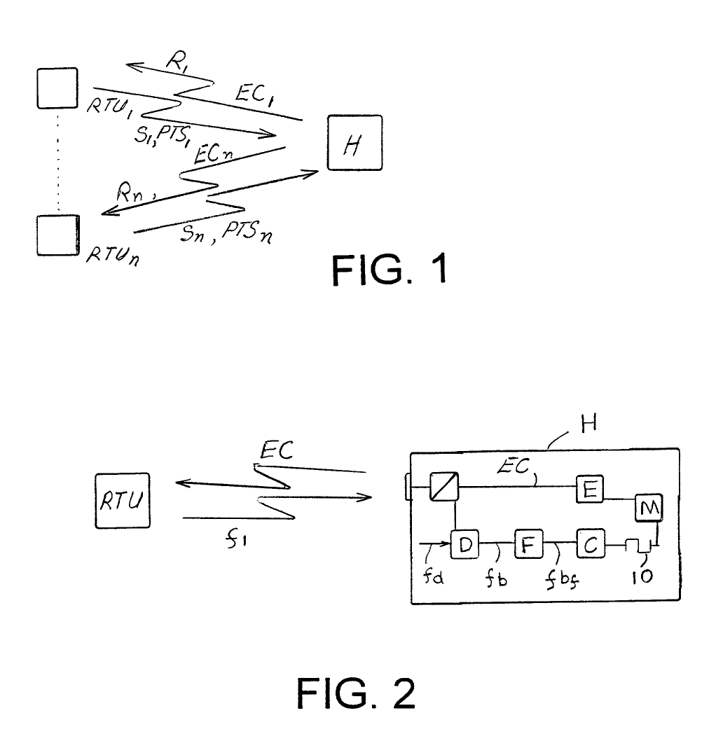

Referring to FIG. 1, remote transmitter units 1-n, RTU₁-RTUN transmit signals S₁-Sₙ to the hub H on a common frequency.

For an RTU to initially acquire the correct transmission frequency, the hub requests the RTU to broadcast a pure tone of a frequency as a PTS pulse tone synchronization signal. The hub detects the frequency from each RTU and broadcasts error correction signals EC₁-ECₙ, which cause the RTU's to broadcast further signals S₁, Sₙ on the correct transmission frequency. If a hub has not heard from a particular RTU for some length of time, the hub directs a request signal R to that RTU, asking the RTU to transmit a ping or a PTS (polled tone signal). The hub receives the ping or PTS signal and processes the signal and produces an error correction signal, which it transmits to that RTU to correct its transmission frequency.

As shown in FIG. 2, the hub H receives a transmission frequency f₁ signal from an RTU and provides that f₁ signal to a detector D. The detector D is also provided with a detector frequency f_{d} that lies outside of the correct transmission frequency. The detector produces a beat frequency, f_{b}, and provides that beat frequency to a filter F. The filter filters the beat frequency f_{b} and passes the filtered frequency f_{b} to a comparator C. The comparator produces a digital waveform 10, which is measured M. The measure is provided to an error calculator E, which causes the hub to transmit an error correction signal to the particular RTU. When the measurement falls within accepted ranges, no error correction signal is transmitted.

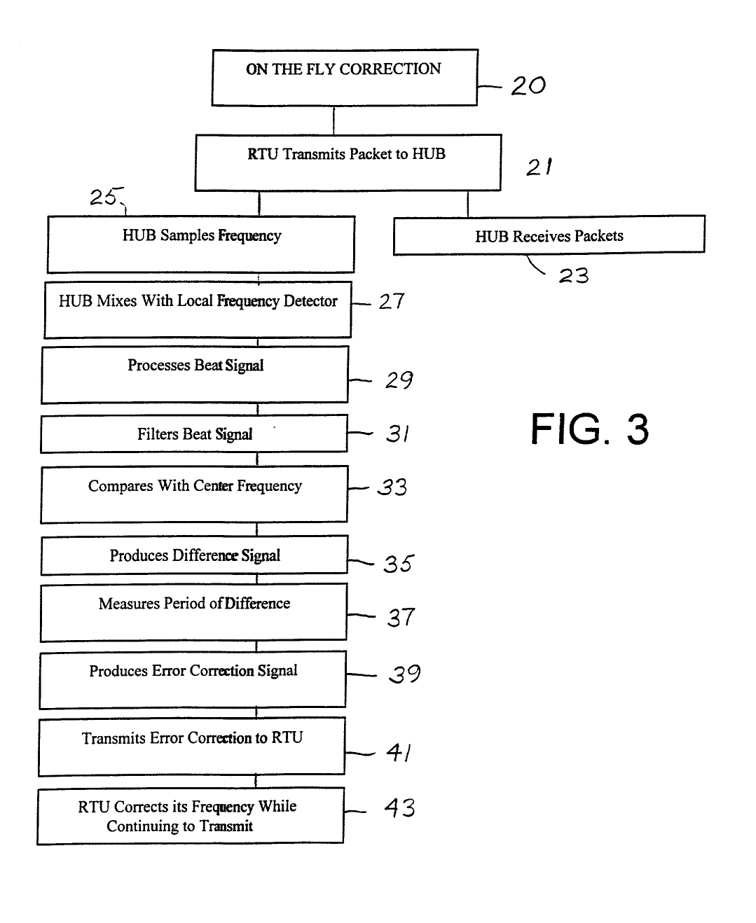

As shown in FIG. 3 on the fly, correction 20 is provided as an RTU transmits packets to a hub 21. The hub receives the packets 23 and samples the frequency 25. The hub mixes the sampled frequency with local frequency in a detector 27 and produces a beat signal 29. The beat signal is filtered 31 and compared with a center frequency 33. A different signal is produced 35; the period of difference is measured 37 and an error correction signal is produced 39. The hub transmits an error correction to the RTU 41, and the RTU corrects its frequency 43 while continuing to transmit.

When the hub has not heard from a particular RTU over a period of time, the hub periodically provides error correction 45 by polling the RTU and requesting a pure tone 47. The RTU transmits a short pure tone ping 49. The hub mixes the frequency of the ping with a distinct local frequency in a detector 27.

The RTU corrects its frequency in preparation for the next transmission.

As shown in FIG. 1, a hub H receives 2 and sends 3 signals from and to multiple receiver/transmitter units (RTU's), RTU₁-RTUₙ. RTU's 1-n transmit signals S₁-Sₙ to the hub. When the hub detects frequency errors in the incoming signals S₁-Sₙ, the hub addresses error correction signals EC₁-ECₙ to specific RTU's. The RTU's correct their transmitting frequency and transmit signals S₁-Sₙ using the correct frequency.

The error corrections occur on-the-fly, with the hub, sampling frequencies of signals S₁-Sₙ as they arrive, and sends error correction signals EC during the transmitting of signals S₁-Sₙ.

Alternatively or in addition, when individual RTU's have not transmitted to the hub for predetermined periods of time or periodically, the hub H transmits request signals R to the RTU's. In response each hub sends a pure tone signal ping PTS₁-PT_{N} to the hub. The hub senses the drift of each pure tone signal and sends an error correction signal EC₁-ECₙ to the RTU's RTU₁-RTUₙ.

As shown in FIG. 2, hub H receives a signal S at frequency f₁ from an RTU. The frequency f₁ of the received signal S may have drifted from the target frequency F. Frequency f₁ is fed to a detector D. A detector frequency f_{d} is also fed to the detector which mixes frequencies f₁ and f to produce a beat frequency f_{b} The beat frequency f_{b} is passed through filter F.

The filtered beat frequency f_{bf} starts a time counter and a beat counter. When the first edge of the beat signal arrived, a counter C and a beat counter B are started. When a sufficient number of beats has been counted, the number of beats N from beat counter B and the value V in the time counter are made available to a digital signal processor P. By dividing the time value Va by the number of beats N, the period between beats is determined. That period is related to the shift of the RTU transmission frequency. The processor P uses that information to produce the error correction signal EC which is transmitted to the RTU from which the pure tone ping was received or the signals have been or are being received.

Referring to FIG. 3, “on the fly” correction 20 is made as an RTU transmits 21 packets to the hub. The hub received 23 the packets and processes information in the packets or retransmits the packets to the intended receiver. At the same time or “on the fly” the hub samples 25 the frequency of the RTU transmissions. The hub mixes 27 the received frequency with a local frequency in a detector and produces 29 a beat frequency. The hub counts the number of beats over a period of time and produces 35 a difference signal. The hub measures 37 the period of the difference and produces 39 an error correction signal. The hub transmits 41 the error correction signal to the RTU. The RTU corrects 43 its frequency while continuing to transmit.

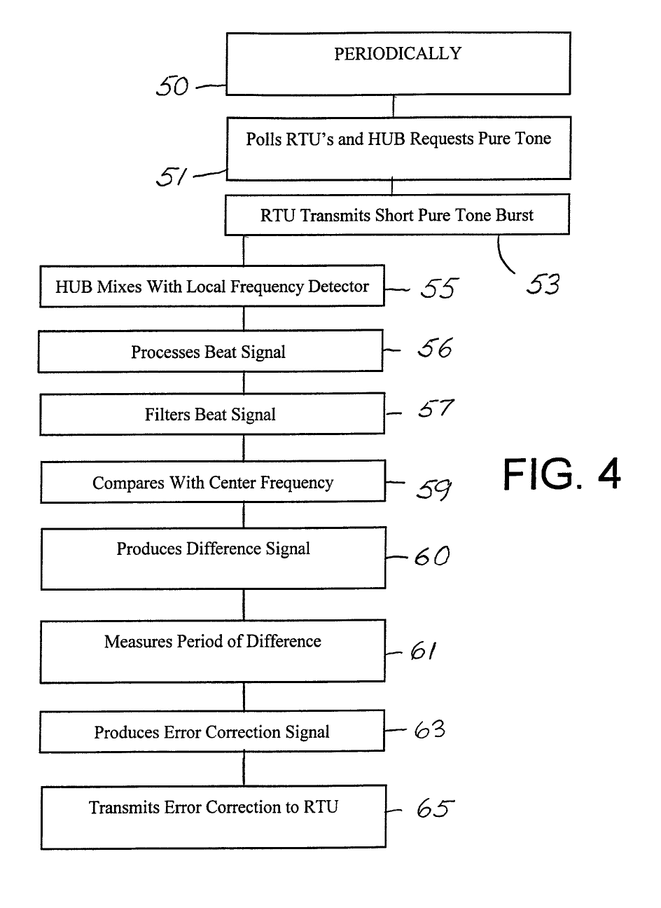

As shown in FIG. 4, when one or more RTU's has not transmitted for a predetermined time the hub periodically 50 polls 51 the RTU's, requesting a pure tone. Each RTU transmits 53 a short pure tone burst. The hub mixes 55 the tone burst with a local frequency and produces 56 a beat signal. The beat signal is filtered 57 and is compared 60 with a center frequency. A difference signal is produced 59. The period of the difference signal is measured 61, and an error correction signal is produced 63. The error correction signal is transmitted 65 to the RTU.

Each RTU is polled in sequence. The error correction signal is provided to an RTU before the next RTU is polled. Each RTU corrects its frequency so that its next transmission will be on the desired frequency.

While the invention has been described with reference to specific embodiments, modifications and variations of the invention may be constructed without departing from the scope of the invention, which is defined in the following claims.

I claim:

1. A method of synchronization of receiver/transmitter units, comprising providing feedback to receiver/transmitter units of frequency error in transmissions to a hub from the receiver/transmitter units.

2. The method of claim 1, further comprising changing frequency outputs of the receiver/transmitter units according to the feedback for correcting transmission frequency of the receiver/transmitter units.

3. The method of claim 1, further comprising requesting a pure tone from each receiver/transmitter unit and broadcasting a pure tone from each receiver/transmitter unit in response to the requesting.

4. The method of claim 3, further comprising receiving the pure tone broadcast from each receiver/transmitter unit, detecting each pure tone, and producing a beat frequency with a hub detector.

5. The method of claim 4, further comprising filtering the beat frequency and passing the filtered beat frequency to a computer.

6. The method of claim 5, further comprising producing a signal waveform with the comparator and measuring a period of the waveform.

7. The method of claim 6, further comprising calculating error in one receiver/transmitter unit transmission frequency according to the measured period of the waveform, and sending a correction value to the receiver/transmitter unit as the feedback to that unit.

8. The method of claim 7, further comprising using the correction value to correct transmission frequency when transmitting from the receiver/transmitter unit.

9. The method of claim 7, wherein the correction value is about four parts per million of the transmission frequency.

10. The method of claim 4, further comprising filtering the beat frequency, passing the filtered beat frequency to a counter and to a beat counter, counting beats with the beat counter and determining a time period with the counter, providing the beats count and the time period to a processor and producing an error correction signal with the processor, transmitting the error correction signal from the hub to the receiver/transmitter unit and using the error correction signal in the receiver/transmitter unit for correcting transmission frequency in transmissions from the receiver/transmitter unit.

11. The method of claim 2, further comprising receiving in the hub transmissions from the receiver/transmitter unit, mixing received frequency with a local frequency at the hub and producing beats, determining periods between beats and creating an error correction signal according to periods between beats, transmitting the error correction signal to the receiver/transmitter units and correcting transmission frequency in the receiver/transmitter unit during its transmissions according to the error correction signal received by the receiver/transmitter unit.

12. A transmission frequency correction system comprising a hub having a transmitter and a receiver, a plurality of receiver/transmitter units communicating with the hub for receiving data packets from the hub and transmitting data packets at an established frequency to the hub for transmitting pure tones to the hub and for receiving error correction signals from the hub, a detector in the receiver of the hub, a frequency source connected to the detector, an output connected to the detector for providing beats, a filter connected to the output for filtering the beats, a counter connected to the filter for measuring time from a start of one beat, a beat counter connected to the output for counting beats from the start of the one beat, a processor connected to the counter and to the beat counter for calculating a number of beats within a predetermined time and for determining thereby difference of the transmitted frequency from a desired frequency and producing an error correction signal, the hub transmitter connected to the processor for transmitting the error correction signal to the receiver/transmitter unit.

13. The system of claim 12, further comprising a polling sequence controller in the hub for successively polling each receiver/transmitter unit communicating with the hub for requesting a pure tone frequency pulse from each hub.

14. Common mode frequency offset correction process for frequency synchronization of receiver/transmitter units (RTU's) comprising receiving a transmitted frequency from an RTU, processing the received frequency by mixing the received frequency with a distinct local frequency at a hub, producing a beat signal, filtering the beat signal, producing a digital waveform from the beat signal, measuring a period of the digital waveform, producing an error correction signal from the measuring, transmitting the error correction signal to the RTU, correcting the transmitted frequency of the RTU according to the error correction signal, thereby correcting common mode frequency and synchronizing transmission frequency of the RTU with an established transmission frequency.

15. The process of claim 14, further comprising polling each of the RTU's communicating with the hub and requesting a pure tone signal from each RTU, conducting the processing of each pure tone signal from each RTU followed by the producing of the error correction and the transmitting of each error correction signal from the hub to each RTU.
